(19) United States
(12) Patent Application Publication
(10) Pub. No.: US 2013/0182991 A1
(43) Pub. Date: Jul. 18, 2013

(54) THRUST ROLLER BEARING AND THRUST ROLLER BEARING APPARATUS

(71) Applicant: JTEKT CORPORATION, Osaka (JP)

(72) Inventor: Ryou TAKAHASHI, Kashiwara-shi (JP)

(73) Assignee: JTEKT CORPORATION, Osaka (JP)

(21) Appl. No.: 13/728,724

(22) Filed: Dec. 27, 2012

(30) Foreign Application Priority Data
Jan. 13, 2012 (JP) 2012-005443

(51) Int. Cl. F16C 19/30

(52) U.S. Cl. CPC F16C 19/305
USPC 384/623

(57) ABSTRACT

A plurality of cage bars of a cage is configured so as to project inward in the radial direction from an inner periphery of an annular portion and to be apart from each other in the circumferential direction. The radially inner side of each pocket defined by two cage bars adjacent to each other in the circumferential direction and the annular portion is open in the radial direction. A concave portion is formed at a corner of the pocket, which is located at the radially outer side.

INCORPORATION BY REFERENCE

The disclosure of Japanese Patent Application No. 2012-005443 filed on Jan. 13, 2012 including the specification, drawings and abstract, is incorporated herein by reference in its entirety.

### BACKGROUND OF THE INVENTION

1. Field of the Invention

The invention relates to a thrust roller bearing, and a thrust roller bearing apparatus that includes a thrust roller bearing.

2. Description of Related Art

Japanese Patent Application Publication No. 11-334029 (JP 11-344029 A) describes a conventional thrust roller bearing. The thrust roller bearing includes a first bearing ring, a second bearing ring, a plurality of cylindrical rollers, and a thrust roller bearing cage. The cylindrical rollers are held, by the thrust roller bearing cage, between the first bearing ring and the second bearing ring so as to be apart from each other in the circumferential direction.

The thrust roller bearing cage has an outer annular portion, an inner annular portion, and a plurality of cage bars, and the outer annular portion is located radially outward of the inner annular portion. The cage bars are arranged so as to be apart from each other in the circumferential direction of the inner annular portion. The cage bars connect the outer annular portion and the inner annular portion to each other. An area surrounded by two cage bars adjacent to each other in the circumferential direction, the outer annular portion, and the inner annular portion constitutes a pocket in which a corresponding one of the cylindrical rollers is accommodated.

In the conventional thrust roller bearing, lubricant that flows radially outward from the radially inner side due to a centrifugal force is not reliably retained between the cylindrical rollers and the thrust roller bearing cage. This causes a problem that abnormal abrasion or seizure is likely to occur in sliding portions such as raceway surfaces. Further, this problem becomes prominent when the cylindrical rollers of the thrust roller bearing roll at a high speed.

### SUMMARY OF THE INVENTION

It is an object of the invention to provide a thrust roller bearing and a thrust roller bearing apparatus, in which lubricant is more reliably retained between rollers and a thrust roller bearing cage to suppress abnormal abrasion and seizure of sliding portions such as raceway surfaces.

An aspect of the invention relates to a thrust roller bearing, including: a first bearing ring; a second bearing ring; a plurality of rollers arranged between the first bearing ring and the second bearing ring; and a cage that holds the rollers. The cage has a comb-shape in which cage bars project inward in a radial direction from an inner periphery of an annular portion so as to form pockets, in which the rollers are accommodated, between the cage bars. A concave portion is formed at a corner which faces a corresponding one of the pockets and at which an extended line of a rolling contact surface of each of the cage bars, on which a corresponding one of the rollers rolls, intersects with an extended line of an inner face of the annular portion, which faces the corresponding one of the pockets.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a radial sectional view showing a cylindrical roller thrust bearing apparatus according to an embodiment of the invention;

FIG. 2 is a perspective view showing part of a cage of the cylindrical roller thrust bearing apparatus;

FIG. 3 is a view showing a distal end-side major portion of one of cage bars of the cage, as viewed from one side of the cage in the axial direction;

FIG. 4 is a view showing a snap ring of the cylindrical roller thrust bearing apparatus, as viewed from one side of the snap ring in the axial direction;

FIG. 5 is a perspective view showing the cage and a plurality of cylindrical rollers accommodated in respective pockets of the cage;

FIG. 6 is a circumferential sectional view schematically showing the cage and the cylindrical rollers accommodated in the respective pockets of the cage, taken along a section that extends in a direction indicated by an arrow A in FIG. 5; and

FIG. 7 is a view showing a cylindrical roller thrust bearing according to a reference example, and corresponding to FIG. 6.

### DETAILED DESCRIPTION OF EMBODIMENTS

Hereinafter, an embodiment of the invention will be described in detail with reference to the accompanying drawings.

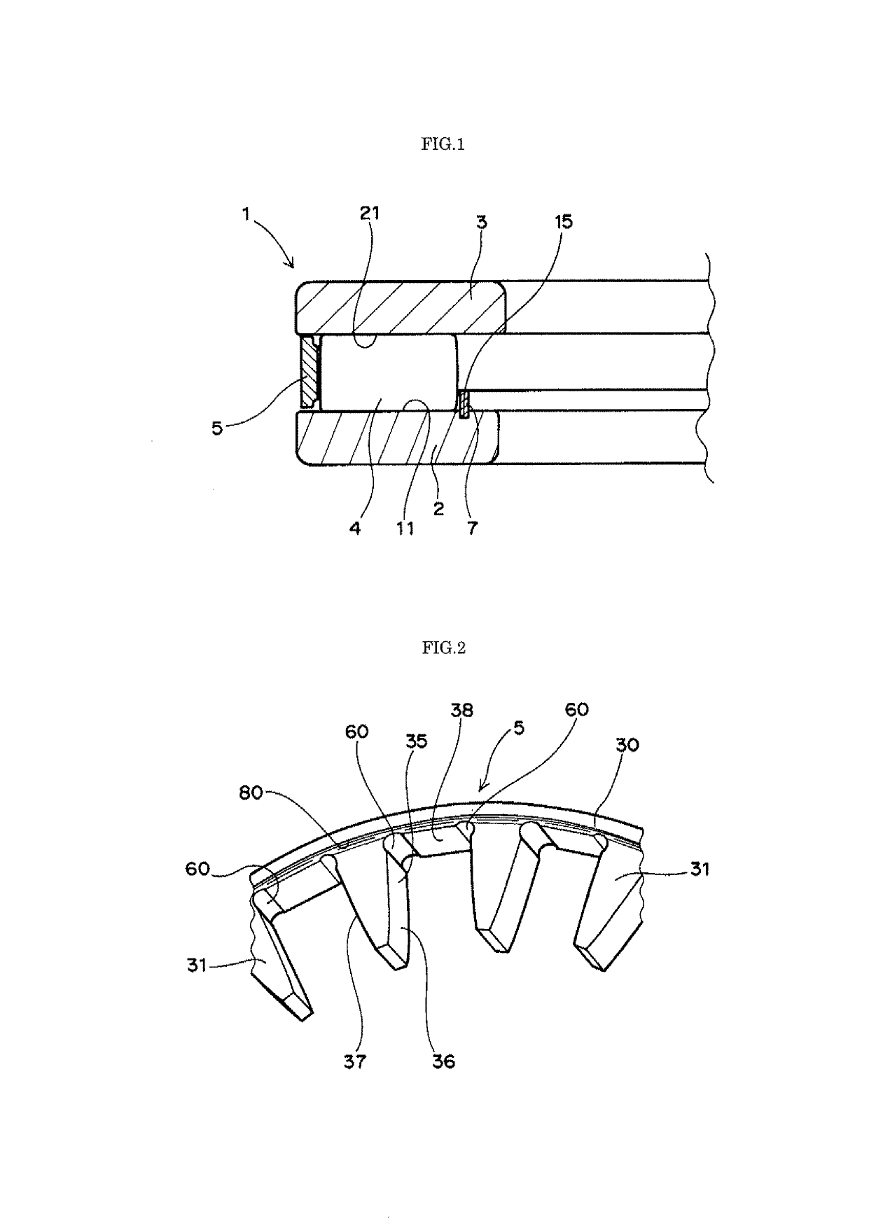

FIG. 1 is a radial sectional view showing a cylindrical roller thrust bearing apparatus according to an embodiment of the invention.

The cylindrical roller thrust bearing apparatus includes a cylindrical roller thrust bearing 1 and an annular snap ring 7. The cylindrical roller thrust bearing (hereinafter, simply referred to as “cylindrical roller bearing”) includes a first bearing ring 2, a second bearing ring 3, a plurality of cylindrical rollers 4, and a thrust roller bearing cage (hereinafter, simply referred to as “cage”) 5.

The cage 5 has a comb-shape. The cage 5 is a single-piece member, and formed by machining brass. By forming the cage 5 as a single-piece member, the number of components and the number of man-hours for assembling the cage 5 are reduced to achieve cost reduction. The cage 5 is guided by the second bearing ring 3, at a position at the outer peripheral side of the first and second bearing rings 2, 3. Because the cage 5 is guided at a position at the outer peripheral side of the bearing rings as described above, lubricant (e.g., grease or lubricant oil) that has flowed from the radially inner side is retained in the cage more efficiently.

An end face of the first bearing ring 2, which is on the second bearing ring 3 side, has a planar raceway surface 11, and an end face of the second bearing ring 3, which is on the first bearing ring 2 side, has a planar raceway surface 21. The cylindrical rollers 4 are held by the cage 5 between the raceway surface 11 of the first bearing ring 1 and the raceway surface 21 of the second bearing ring 3 so as to be apart from each other in the circumferential direction.

As shown in FIG. 1, the end face of the first bearing ring 2, which is on the second bearing ring 3 in the axial direction, has an annular groove 15. The snap ring 7 is press-fitted into the annular groove 15. The central axis of the snap ring 7 substantially coincides with the central axis of the second bearing ring 3. The snap ring 7 is arranged radially inward of the cylindrical rollers 4. The snap ring 7 is provided to prevent the cylindrical rollers 4 from moving inward in the radial direction. In a state where the cylindrical roller bearing 1 is driven and a radially outward centrifugal force is applied to the cylindrical rollers 4 so that the cylindrical rollers 4 move radially outward, the cylindrical rollers 4 are located apart from the snap ring 7. Thus, smooth rolling of the cylindrical rollers 4 is ensured.

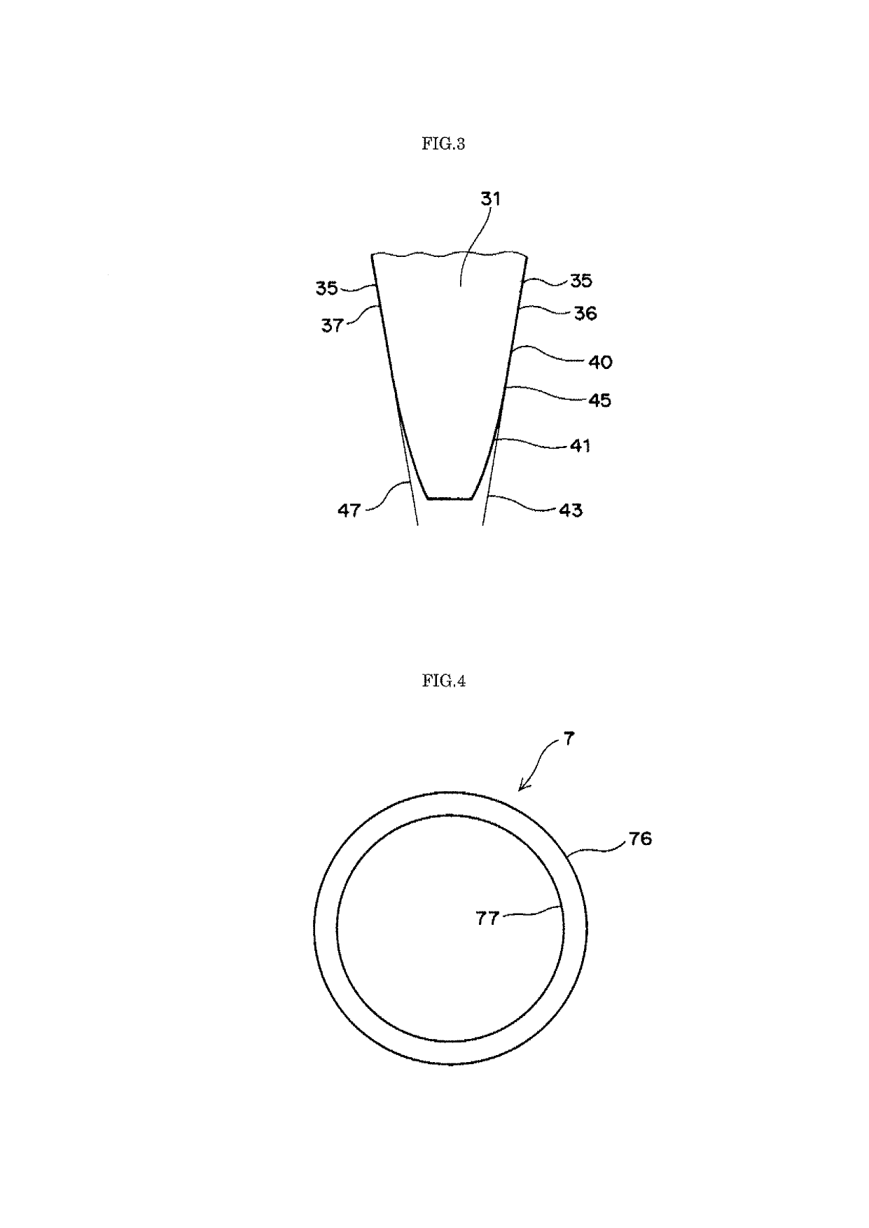

FIG. 2 is a perspective view of part of the cage 5.

As shown in FIG. 2, the cage 5 has a comb-shape, and has an annular portion 30 and a plurality of cage bars 31. Each of the cage bars 31 projects radially inward from a radially inner end portion of the annular portion 30. The cage bars 31 are arranged so as to be apart from each other in the circumferential direction of the annular portion 30. An area surrounded by the annular portion 30 and two cage bars 31 adjacent to each other in the circumferential direction forms a pocket 35 in which a corresponding one of the cylindrical rollers 4 is accommodated. The radially inner side of the pocket 35 opens toward the inner side in the radial direction. By forming the cage 5 in a comb-shape, the distance between adjacent cylindrical rollers 4 is reduced to increase the number of cylindrical rollers 4, thereby increasing the load rating, while a sufficiently high strength of the cage bars 31 is ensured. Further, by forming the cage 5 in a comb-shape so that only one annular portion is required, the weight of the cage 5 is reduced and the material cost for the cage 5 is reduced to reduce the cost of manufacturing the cage 5.

As shown in FIG. 2, each of the cage bars 31 has a first rolling contact surface 36 on one side in the circumferential direction, and a second rolling contact surface 37 on the other side in the circumferential direction. Each of the first rolling contact surface 36 and the second rolling contact surface 37 faces the pocket 35, and the cylindrical roller 4 rolls on the first rolling contact surface 36. A concave portion 60 is formed at each of all the corners of the pocket 35, which are located at the radially outer side. More specifically, the concave portion 60 is formed at a corner which faces the pocket 35 and at which an extended line of the first rolling contact surface 36 of the cage bar 31, on which the cylindrical roller 4 rolls, intersects with an extended line of an inner face of the annular portion 30, which faces the pocket 35. Further, the concave portion 60 is also formed at a corner which faces the pocket 35 and at which an extended line of the second rolling contact surface 37 of the cage bar 31, on which the cylindrical roller 4 rolls, intersects with an extended line of the inner face of the annular portion 30, which faces the pocket 35. Each of the concave portions 60 extends in the axial direction of the cage 5. Each of the concave portions 60 is open at both sides in the axial direction of the cage 5.

As shown in FIG. 2, each of one axial end face and the other axial end face of the annular portion 30 of the cage 5 has an annular groove 80. The annular groove 80 is formed so as to accommodate lubricant that has flowed from the radially inner side, and restrict the lubricant from flowing radially outward of the cage 5.

FIG. 3 is a view showing a distal end-side major portion of one of the cage bars 31 of the cage 5, as viewed from one side of the cage 5 in the axial direction.

As shown in FIG. 3, the distal end portion of the cage bar 31 has been subjected to crowning so that the thickness of the cage bar 31 in the circumferential direction is reduced in a direction toward the radially inner side. More specifically, the first rolling contact surface 36 has a planar portion 40 and a curved portion 41. The planar portion 40 is a portion of the first rolling contact surface 36, which is on the annular portion 30 side. The curved portion 41 is contiguous with the radially inner end of the planar portion 40, and extends to the radially inner end of the first rolling contact surface 36. The curved portion 41 is formed by subjecting the radially inner portion of the first rolling contact surface 36 to crowning so that the thickness of the cage bar 31 in the circumferential direction is reduced in a direction toward the radially inner side.

The second rolling contact surface 37 has the same structure as the first rolling contact surface 36, and the radially inner portion of the second rolling contact surface 37 has been subjected to crowning. In FIG. 3, a reference numeral 45 denotes a connection portion at which the planar portion 40 and the curved portion 41 are connected to each other. A reference numeral 43 denotes an extended plane of the planar portion 40, which extends radially inward. A reference numeral 47 denotes an extended plane of a planar portion of the second rolling contact surface 37, which extends radially inward. The extended planes 43, 47 are drawn to facilitate understanding of crowning performed on the first and second rolling contact surfaces 36, 37.

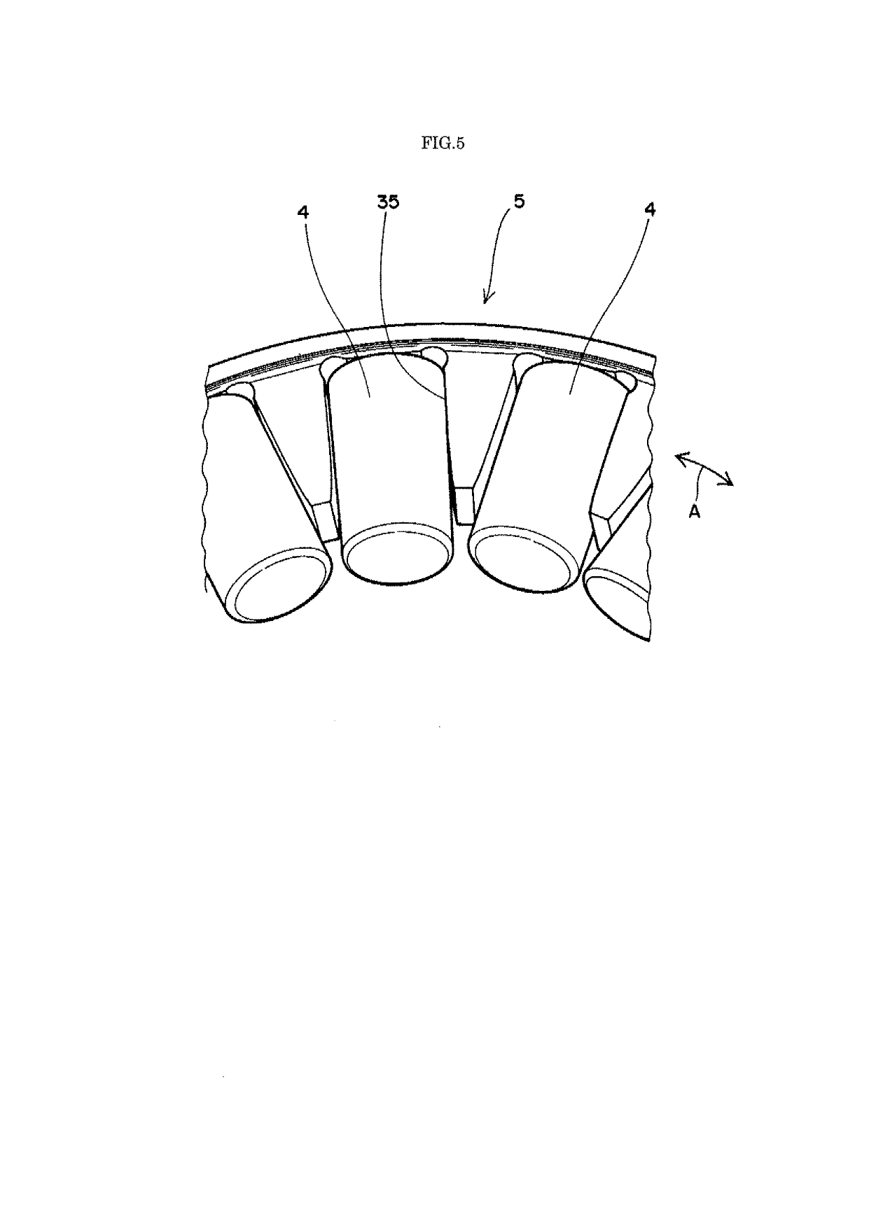

FIG. 4 is a view showing the snap ring 7, as viewed from one side of the snap ring 7 in the axial direction.

As shown in FIG. 4, the snap ring 7 is formed in a cylindrical shape, and has a cylindrical outer periphery 76 and a cylindrical inner periphery 77. The central axis of the cylindrical outer periphery 76 substantially coincides with the central axis of the cylindrical inner periphery 77.

FIG. 5 is a perspective view showing the cage 5 and a plurality of the cylindrical rollers 4 accommodated in the respective pockets 35 of the cage 5.

As shown in FIG. 5, the radial dimension of the pocket 35 of the cage 5 is smaller than the axial length of the cylindrical roller 4, and part of the cylindrical roller 4 is exposed on the outside of the pocket 35 of the cage 5. In the present embodiment, in a state where the cylindrical roller 4 is located at the radially outermost position in the pocket 35, approximately three-quarters of the cylindrical roller 4 in the axial direction are accommodated in the pocket 35 and approximately a quarter of the cylindrical roller 4 in the axial direction is exposed on the outside of the pocket 35.

Note that, in the invention, it is preferable that 75% or more of the length of the cylindrical roller 4 in its axial direction be within the pocket 35 in the state where the cylindrical roller 4 is located at the radially outermost position in the pocket 35. This arrangement makes it possible to reliably guide the cylindrical roller 4 in the cage 5 and to ensure sufficient strength of the cage 5. This is because if the pocket 35 has a length of 75% or more of the length of a portion of the cylindrical roller 4, which has been subjected to crowning, it is possible to reliably form a linear portion and a contact portion of the cylindrical roller 4.

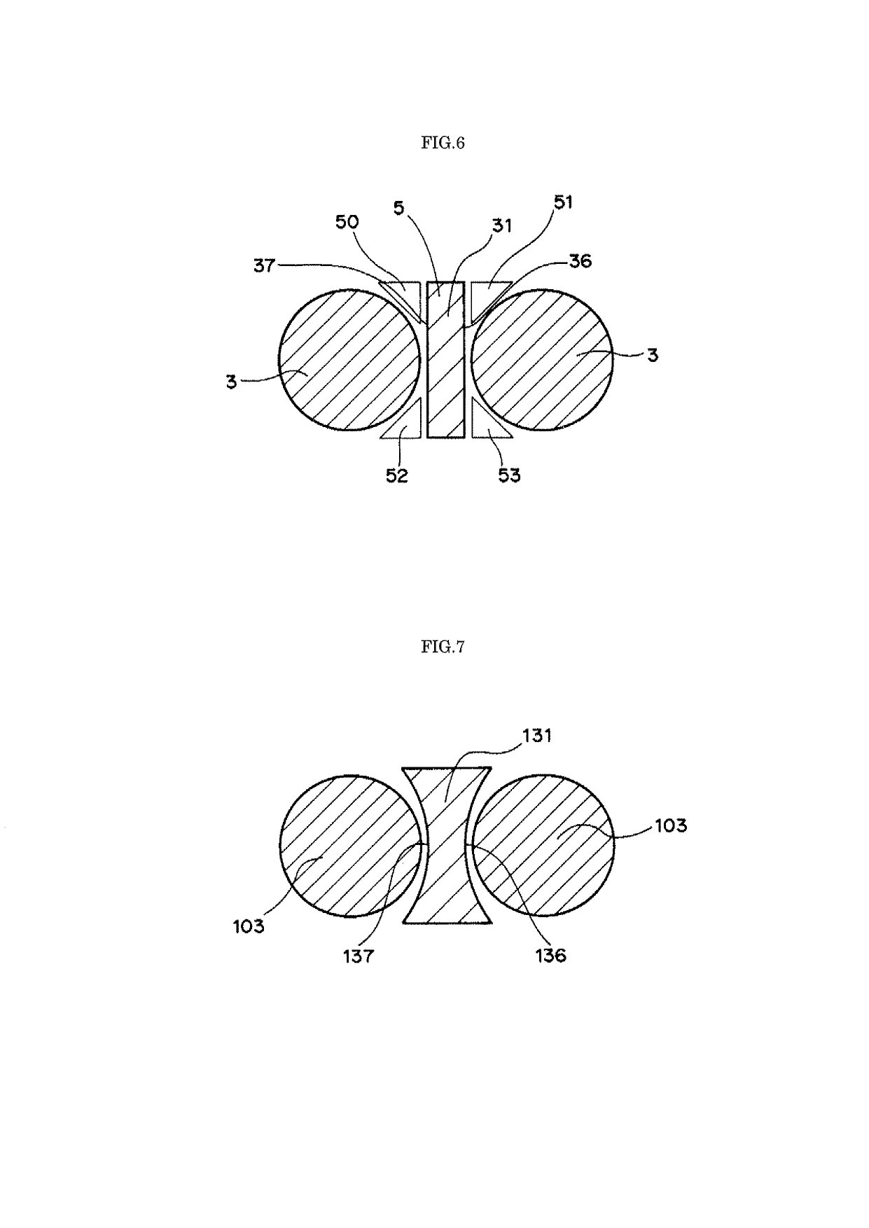

FIG. 6 is a circumferential sectional view schematically showing the cage 5 and the cylindrical rollers 4 accommodated in the pockets 35 of the cage 5, taken along a section that extends in a direction indicated by an arrow A in FIG. 5. FIG. 6 shows one of the cage bars 31 and the cylindrical rollers 4 located on respective sides of the cage bar 31 in the circumferential direction.

As shown in FIG. 6, the cage bar 31 of the cage 5 has a rectangular sectional shape in the circumferential direction. In a section in the circumferential direction in FIG. 6, each of the first rolling contact surface 36 of the cage bar 31 and the second rolling contact surface 37 of the cage bar 31 has a linear shape. Each of the first rolling contact surface 36 and the second rolling contact surface 37 is a surface of which the generating, line is a straight line that extends in the axial direction of the annular portion 30. Each of the first rolling contact surface 36 and the second rolling contact surface 37 is a surface that is substantially parallel to the axial direction of the annular portion 30 (see FIG. 1). In this way, the clearances, indicated by reference numerals 50 to 53, between axial end portions of the cage bar 31 and the cylindrical rollers 4 are made large. Thus, it is possible to retain a larger amount of lubricant in the clearances. Note that, in the present embodiment, each of the first rolling contact surface 36 and the second rolling contact surface 37 is a surface that is substantially parallel to the axial direction of the annular portion 30, and therefore the cage 5 and the cylindrical rollers 4 are configured so as not to form an assembly.

With the cylindrical roller bearing 1 according to the above-described embodiment, the cage 5 has a comb-shape in which the cage bars 31 project radially inward from the inner periphery of the annular portion 30, and the radially inner side of the pocket 35 of the cage 5 is open in the radial direction. This makes it possible to introduce a larger portion of the lubricant that flows radially outward from the radially inner side due to a centrifugal force, into the pocket 35 through the opening located at the radially inner side of the pocket 35. Further, the concave portions 60 are formed at the corners at which the extended lines of the rolling contact surfaces 36, 37 of the cage bar 31, on which the cylindrical rollers 4 roll, intersect with the extended lines of the inner face of the annular portion 30, which faces the pocket 35. This makes it possible to accommodate a major portion of the lubricant, which is introduced into the pocket 35, in the concave portions 60. Accordingly, a large amount of lubricant is accommodated in the pocket 35 as compared with a conventional thrust roller bearing cage. This makes it possible to efficiently suppress abnormal abrasion and seizure of sliding portions such as the raceway surfaces 11, 21, as compared with the conventional techniques.

In the cylindrical roller bearing 1 according to the above-described embodiment, the distal end portions of the rolling contact surfaces 36, 37 of the cage bar 31 have been subjected to crowning so that the thickness of the cage bar 31 in the circumferential direction is reduced in a direction toward the radially inner side. Accordingly, the cylindrical roller 4 in the pocket 35 does not receive any high edge load from the distal end portions of the rolling contact surfaces 36, 37 of the cage bar 31. This makes it possible to suppress damage to the cylindrical roller 4 and the cage 5.

In the cylindrical roller bearing 1 according to the above-described embodiment, each of the rolling contact surfaces 36, 37 of the cage bar 31 is a surface of which the generating line is a straight line that extends in the axial direction of the annular portion 30, and each of the rolling contact surfaces 36, 37 of the cage bar 31 is a surface that is substantially parallel to the axial direction of the annular portion 30. In this way, the clearances between the axial end portions of the rolling contact surfaces 36, 37 of the cage bar 31 and the cylindrical rollers 4 are made large. The clearances are used as lubricant reservoir. Therefore, it is possible to retain a larger amount of lubricant in the pocket 35. This makes it possible to efficiently suppress abnormal abrasion and seizure of sliding portions such as the raceway surfaces 11, 21, as compared with the conventional techniques.

FIG. 7 is a view showing a cylindrical roller bearing according to a reference example, and corresponding to FIG. 6. As shown in FIG. 7, in a case where each of rolling contact surfaces 136, 137 of a cage bar 131 is a concave surface that has a shape that follows a cylindrical roller 103, clearances between the rolling contact surface 136, 137 and the cylindrical roller 103 are small. This makes it difficult to retain the lubricant between the cage bar 131 and the cylindrical rollers 103.

Further, in the cylindrical roller thrust bearing apparatus according to the invention, the cylindrical rollers 4 are prevented from moving radially inward by the snap ring 7 is arranged in the annular groove 15 formed in the end face of in the first bearing ring 2, which is on the second bearing ring 3 side in the axial direction. Accordingly, even when the cylindrical roller bearing 1 is not driven and no centrifugal force is applied to the cylindrical rollers 4, the cylindrical rollers 4 are not removed from the cage 5 in a direction toward the radially inner side.

In the above-described embodiment, the concave portion 60 is formed at each of all the corners between the cage bar 31 and the annular portion 30. However, in the invention, the concave portion 60 need not be formed at each of all the corners between the cage bar 31 and the annular portion 30. The concave portion 60 may be formed at at least one of the corners.

Further, in the present embodiment, the cage 5 is a single-piece member, and formed by machining brass. However, in the invention, the cage may be made of any type of metal, and may be formed by any manufacturing method other than machining. Further, in the invention, the cage may be made of a resin material and formed by injection molding. Further, in the invention, the cage may be formed, for example, by fixedly screwing each cage bar to the annular portion. Also, the cage need not be formed as a single-piece member.

Further, in the above-described embodiment, both of the first rolling contact surface 36 and the second rolling contact surface 37 of each of the cage bars 31 of the cage 5 are subjected to crowning, However, in the invention, no crowning may be performed on the cage bars 31.

Further, in the above-described embodiment, the rolling contact surfaces 36, 37 on both sides of each of the cage bars 31 in the circumferential direction are surfaces substantially parallel to the axial direction of the annular portion 30. However, in the invention, the rolling contact surfaces, which are end faces on both sides of each cage bar in the circumferential direction, may be, for example, curved surfaces formed in a shape that follows rolling contact surfaces of the rollers, as shown in FIG. 7. Further, in the above-described embodiment, the roller is the cylindrical roller 4. However, in the invention, the roller may be a tapered roller or a convex roller (spherical roller).

According to the invention, it is possible to obtain a thrust roller bearing in which a larger amount of lubricant is retained in pockets of a cage and abnormal abrasion and seizure of sliding portions such as raceway surfaces are suppressed.

What is claimed is:

1. A thrust roller bearing, comprising:
a first bearing ring;
a second bearing ring;
a plurality of rollers arranged between the first bearing ring and the second bearing ring; and
a cage that holds the rollers, wherein:
the cage has a comb-shape in which cage bars project inward in a radial direction from an inner periphery of an annular portion so as to form pockets, in which the rollers are accommodated, between the cage bars, and
a concave portion is formed at a corner which faces a corresponding one of the pockets and at which an extended line of a rolling contact surface of each of the cage bars, on which a corresponding one of the rollers rolls, intersects with an extended line of an inner face of the annular portion, which faces the corresponding one of the pockets.

2. The thrust roller bearing according to claim 1, wherein:
a distal end portion of the rolling contact surface of each of the cage bars has been subjected to crowning so that a thickness of the cage bar in a circumferential direction is reduced toward an inner side in the radial direction.

3. The thrust roller bearing according to claim I, wherein:
the rolling contact surface of each of the cage bars is a surface of which a generating line is a straight line that extends in an axial direction of the annular portion.

4. The thrust roller bearing according to claim 2, wherein:
the rolling contact surface of each of the cage bars is a surface of which a generating line is a straight line that extends in an axial direction of the annular portion.

5. A thrust roller bearing apparatus, comprising:
the thrust roller bearing according to claim 1, wherein:
an end face of the first bearing ring, which is on the second bearing ring side in an axial direction of the thrust rolling bearing, has an annular groove, and
a snap ring that prevents the rollers from moving inward in the radial direction is arranged in the annular groove.

6. A thrust roller bearing apparatus, comprising:
the thrust roller bearing according to claim 2, wherein:
an end face of the first bearing ring, which is on the second bearing ring side in an axial direction of the thrust rolling bearing, has an annular groove, and
a snap ring that prevents the rollers from moving inward in the radial direction is arranged in the annular groove.

7. A thrust roller bearing apparatus, comprising:
the thrust roller bearing according to claim 3, wherein:
an end face of the first bearing ring, which is on the second bearing ring side in an axial direction of the thrust rolling bearing, has an annular groove, and
a snap ring that prevents the rollers from moving inward in the radial direction is arranged in the annular groove.

8. A thrust roller bearing apparatus, comprising:
the thrust roller bearing according to claim 4, wherein:
an end face of the first bearing ring, which is on the second bearing ring side in an axial direction of the thrust rolling bearing, has an annular groove, and
a snap ring that prevents the rollers from moving inward in the radial direction is arranged in the annular groove.
